(19) United States
(12) Patent Application Publication
(10) Pub. No.: US 2025/0301425 A1
(43) Pub. Date: Sep. 25, 2025

(54) UPLINK TRANSMISSION SWITCHING FOR CARRIERS ASSOCIATED WITH MULTIPLE TIMING ADVANCED GROUPS (TAGs)

(71) Applicant: QUALCOMM Incorporated, San Diego, CA (US)

(72) Inventors: Yiqing CAO, Beijing (CN); Peter GAAL, San Diego, CA (US); Timo Ville VINTOLA, San Diego, CA (US); Masato KITAZOE, Tokyo (JP)

(21) Appl. No.: 18/863,984

(22) PCT Filed: Aug. 4, 2022
(86) PCT No.: PCT/CN2022/110209

§ 371 Date: Nov. 7, 2024

(51) Int. Cl. H04W 56/00; H04L 5/00; H04W 36/00

(52) U.S. Cl. CPC H04W 56/0005; H04L 5/0048; H04W 36/00692

(57) ABSTRACT

A method for wireless communication at a user equipment (UE) includes transmitting, to a network node, a first message indicating the UE supports multiple timing advance groups (TAGs). The method also includes transmitting, to the network node, a second message indicating a set of bands supported for uplink transmission switching, a total number of TAGs supported by the UE, and a relationship between each band of the set of bands and one TAG of a set of TAGs supported by the UE. A number of TAGs in the set of TAGs may be equal to or less than the total number of TAGs supported by the UE. The method further includes receiving, from the network node, a configuration based on transmitting the second message.

### FIELD OF THE DISCLOSURE

The present disclosure relates generally to wireless communications, and more specifically to a user equipment (UE) supporting uplink transmission switching for two or more carriers associated with a group of timing advanced groups (TAGs).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

In some wireless communication systems, a UE may receive, from a network node, timing advance information to account for a delay, such as a propagation delay, on different carriers. The timing advance information may be used to synchronize communications between the UE and the network node. The UE may also support communications on a set of bands. In some examples, two or more bands, of the set of bands, that share a same timing advance value may be associated with a same timing advance group (TAG), while other bands of the set of bands may be associated with different TAGs. In some examples, the UE may support uplink (UL) transmission (Tx) switching for carriers while also supporting multiple TAGs. In such examples, the UE may switch a transmission channel (e.g., carrier) from a first band associated with a first timing advance (TA) to a second band associated with a second TA that is less than the first TA. The transmission channel may be switched during a switching period. In some examples, a length of the switching period may increase if the first band and second band are associated with different TAGs. The UE may be unaware of the increase in the length of the switching period, thereby resulting in a potential overlap between a scheduled transmission and an uplink transmission switch.

### SUMMARY

In one aspect of the present disclosure, a method for wireless communication at a UE includes transmitting, to a network node, a first message indicating the UE supports multiple timing advance groups (TAGs). The method further includes transmitting, to the network node, a second message indicating a set of bands supported for uplink transmission switching, a total number of TAGs supported by the UE, and a relationship between each band of the set of bands and one TAG of a set of TAGs supported by the UE. A number of TAGs in the set of TAGs may be equal to or less than the total number of TAGs supported by the UE. The method still further includes receiving, from the network node, a configuration based on transmitting the second message.

Another aspect of the present disclosure is directed to an apparatus including means for transmitting, to a network node, a first message indicating the UE supports multiple TAGs. The apparatus further includes means for transmitting, to the network node, a second message indicating a set of bands supported for uplink transmission switching, a total number of TAGs supported by the UE, and a relationship between each band of the set of bands and one TAG of a set of TAGs supported by the UE. A number of TAGs in the set of TAGs may be equal to or less than the total number of TAGs supported by the UE. The apparatus still further includes means for receiving, from the network node, a configuration based on transmitting the second message.

In another aspect of the present disclosure, a non-transitory computer-readable medium with non-transitory program code recorded thereon is disclosed. The program code is executed by a processor and includes program code to transmit, to a network node, a first message indicating the UE supports multiple TAGs. The program code further includes program code to transmit, to the network node, a second message indicating a set of bands supported for uplink transmission switching, a total number of TAGs supported by the UE, and a relationship between each band of the set of bands and one TAG of a set of TAGs supported by the UE. A number of TAGs in the set of TAGs may be equal to or less than the total number of TAGs supported by the UE. The program code still further includes program code to receive, from the network node, a configuration based on transmitting the second message.

Another aspect of the present disclosure is directed to an apparatus including a processor, and a memory coupled with the processor and storing instructions operable, when executed by the processor, to cause the apparatus to transmit, to a network node, a first message indicating the UE supports multiple TAGs. Execution of the instructions also cause the apparatus to transmit, to the network node, a second message indicating a set of bands supported for uplink transmission switching, a total number of TAGs supported by the UE, and a relationship between each band of the set of bands and one TAG of a set of TAGs supported by the UE. A number of TAGs in the set of TAGs may be equal to or less than the total number of TAGs supported by the UE. Execution of the instructions further cause the apparatus to receive, from the network node, a configuration based on transmitting the second message.

In one aspect of the present disclosure, a method for wireless communication at a network node includes receiving a first message indicating a UE supports multiple TAGs. The method further includes receiving a second message indicating a set of bands supported for uplink transmission switching by the UE, a total number of TAGs supported by the UE, and a relationship between each band of the set of bands and one TAG of a set of TAGs supported by the UE, a number of TAGs in the set of TAGs being equal to or less than the total number of TAGs supported by the UE. The method still further includes transmitting a configuration based on receiving the second message.

Another aspect of the present disclosure is directed to an apparatus including means for receiving a first message indicating a UE supports multiple TAGs. The apparatus further includes means for receiving a second message indicating a set of bands supported for uplink transmission switching by the UE, a total number of TAGs supported by the UE, and a relationship between each band of the set of bands and one TAG of a set of TAGs supported by the UE, a number of TAGs in the set of TAGs being equal to or less than the total number of TAGs supported by the UE. The apparatus still further includes means for transmitting a configuration based on receiving the second message.

In another aspect of the present disclosure, a non-transitory computer-readable medium with non-transitory program code recorded thereon is disclosed. The program code is executed by a processor and includes program code to receive a first message indicating a UE supports multiple TAGs. The program code further includes program code to receive a second message indicating a set of bands supported for uplink transmission switching by the UE, a total number of TAGs supported by the UE, and a relationship between each band of the set of bands and one TAG of a set of TAGs supported by the UE, a number of TAGs in the set of TAGs being equal to or less than the total number of TAGs supported by the UE. The program code still further includes program code to transmit a configuration based on receiving the second message.

Another aspect of the present disclosure is directed to an apparatus including a processor, and a memory coupled with the processor and storing instructions operable, when executed by the processor, to cause the apparatus to receive a first message indicating a UE supports multiple TAGs. Execution of the instructions also cause the apparatus to receive a second message indicating a set of bands supported for uplink transmission switching by the UE, a total number of TAGs supported by the UE, and a relationship between each band of the set of bands and one TAG of a set of TAGs supported by the UE, a number of TAGs in the set of TAGs being equal to or less than the total number of TAGs supported by the UE. Execution of the instructions further cause the apparatus to transmit a configuration based on receiving the second message.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a timing diagram illustrating an example of a network node configuring a UE for uplink (UL) transmission (Tx) switching, in accordance with various aspects of the present disclosure.

FIG. 5 is a flow diagram illustrating an example process performed, for example, by a user equipment (UE), in accordance with various aspects of the present disclosure.

FIG. 6 is a flow diagram illustrating an example process performed, for example, by a network node, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

In some wireless communication systems, a user equipment (UE) may receive, from a network node, timing advance information to account for a delay, such as a propagation delay, on different carriers. The timing advance information may be used to synchronize communications between the UE and the network node. The UE may also support communications on a set of bands. In some examples, two or more bands, of the set of bands, that share a same timing advance value may be associated with a same timing advance group (TAG), while other bands of the set of bands may be associated with different TAGs. In some conventional systems, the UE may support multiple TAGs for inter-band carrier aggregation without supporting uplink (UL) transmission (Tx) switching. In such systems, the UE may report, to the network node, a set of bands supported by the UE and a total number of TAGs supported by the UE. The total number of TAGs may be indicated via a pre-defined parameter, such as supportedNumberTAG. In some examples, each band of the set of bands may be associated with a different TAG if the total number of TAGs equals a total number of bands in the set of bands. In other examples, two or more bands may be associated with a same TAG if the total number of TAGs is less than the total number of bands in the set of bands. In such examples, the network node may associate the bands with the TAGs. However, the UE may be unaware of the association between the bands and TAGS.

In some examples, the UE may support UL Tx switching for carriers while also supporting multiple TAGs. In such examples, the UE may switch a transmission channel (e.g., carrier) from a first band associated with a first timing advance (TA) to a second band associated with a second TA that is less than the first TA. The transmission channel may be switched during a switching period. In some examples, a length of the switching period may increase if the first band and second band are associated with different TAGs. The UE may fail to account for the increase in the length of the switching period because the UE may be unaware of the association between each band and a TAG. The failure to account for the increase in the length of the switching period may result in a potential overlap between a scheduled transmission and an uplink transmission switch. It may be desirable for the network to configure for each band of a set of bands supported by the UE, a corresponding TAG of the set of TAGs. It may be further desirable for the network to indicate the configuration to the UE, such that the UE may properly adjust a length of the switching period when switching between bands.

Various aspects of the present disclosure are directed to performing, at a UE, an UL Tx switch between bands that are associated with a same TAG or different TAGs. In some aspects, the UE indicates, to a network node, a set of bands supported for uplink switching, a total number of supported TAGs, and an association between each band of the set of bands and a TAG of a set of TAGs supported by the UE. A number of TAGs in the set of TAGs may be equal to or less than the total number of supported TAGs. The UE may receive configuration from the network node for UL Tx switching between bands. In some examples, the configuration indicates, for each band of the set of bands, a corresponding TAG of the set of TAGs. The bands may be associated with the same TAG or different TAGs. The configuration may be received based on indicating the set of bands supported for UL Tx switching, the total number of TAGs supported by the UE, and the relationship between each band of the set of bands and one TAG of the set of TAGs supported by the UE. In some examples, when switching between bands associated with different TAGs, the UE may adjust the length of the switching period based on the configuration received from the network node.

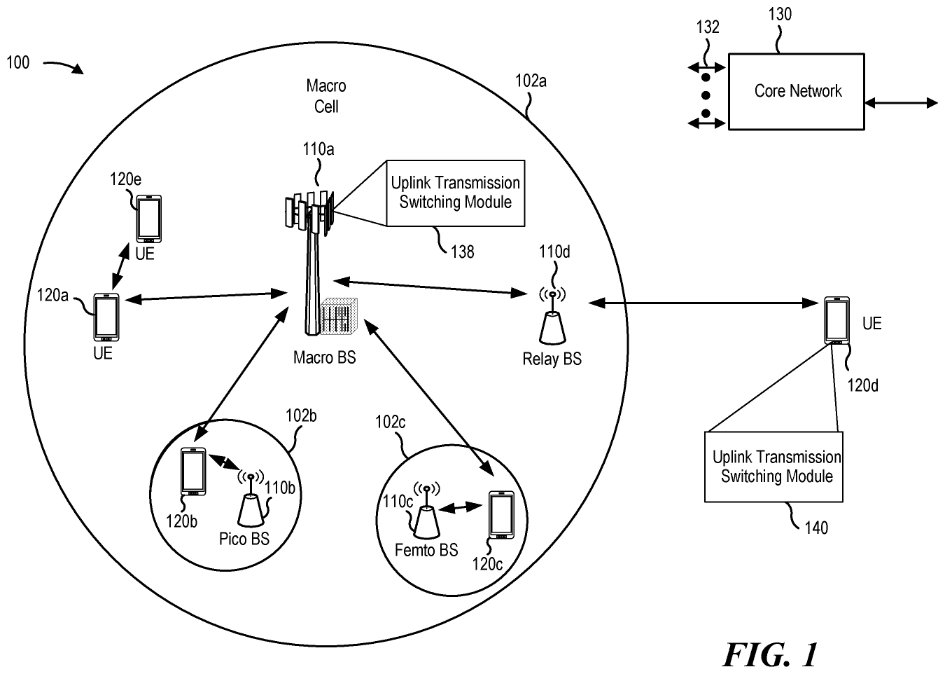

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

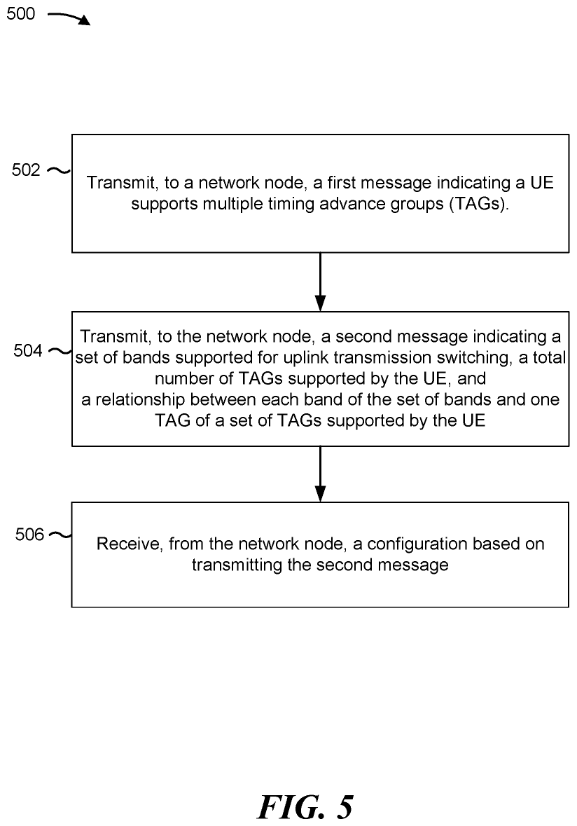

The UEs 120 may include an uplink transmission switching module 140. For brevity, only one UE 120d is shown as including the uplink transmission switching module 140. The uplink transmission switching module 140 may perform one or more steps of the process 500 described with reference to FIG. 5.

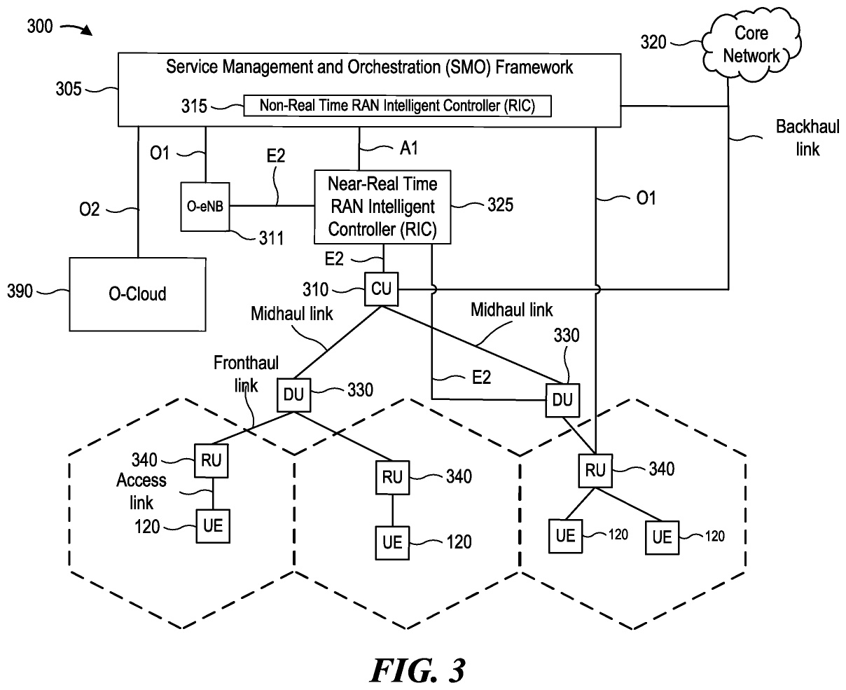

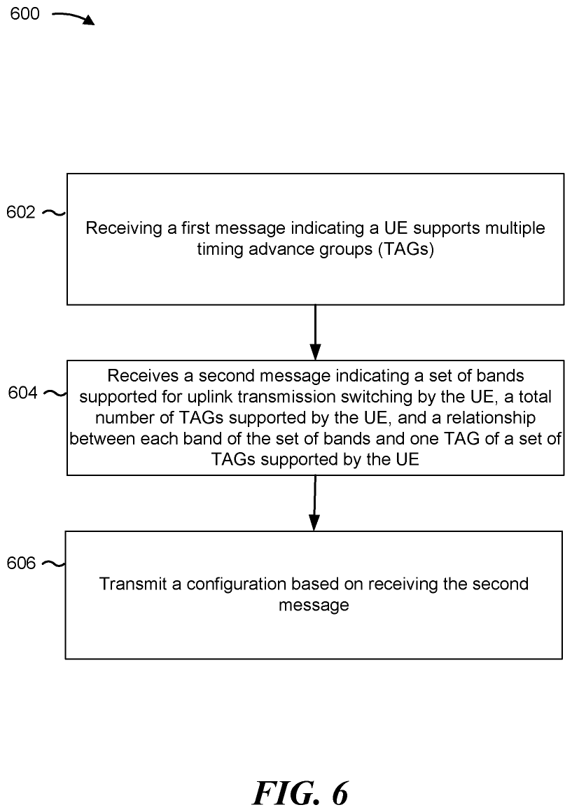

The core network 130 or the base stations 110 or any other network device (e.g., as seen in FIG. 3) may include an uplink transmission switching module 138. The uplink transmission switching module 138 may perform one or more steps of the process 600 described with reference to FIG. 6.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

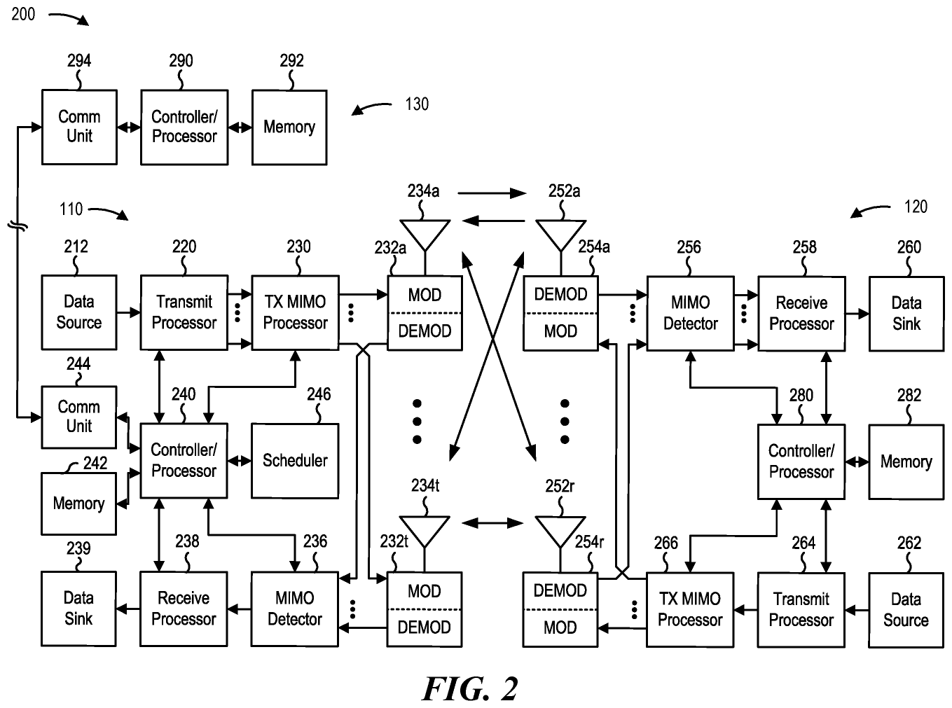

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with UL Tx switching with multiple TAGs as described in more detail elsewhere. For example, the controller/processor 240 of the base station 110, the controller/processor 280 of the UE 120, and/or any other component(s) of FIG. 2 may perform or direct operations of, for example, the processes of FIGS. 5 and 6 and/or other processes as described. Memories 242 and 282 may store data and program codes for the base station 110 and UE 120, respectively. A scheduler 246 may schedule UEs for data transmission on the downlink and/or uplink.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via O1) or via creation of RAN management policies (such as A1 policies).

As discussed, a switching period may increase when a UE switches an uplink channel (e.g., carrier) from a first band associated with a first timing advance (TA) to a second band with a second TA that is smaller than the first TA. Various aspects of the present disclosure are directed to transmitting, by a UE, a message indicating a set of bands supported by the UE for uplink (UL) transmission (Tx) switching, a supported number of multiple timing advance groups (TAGs), and a relationship between one or more bands and one or more TAGs. The relationship may indicate an association between each band and a respective TAG. One or more bands in the set of bands may be associated with the same TAG, and other bands in the set of bands may be associated with different TAGs. Depending on the UE's capabilities, the network node may configure the UE for UL Tx switching between bands within the same TAG or between bands associated with different TAGs. The UE may increase a switching period if the uplink channel switch is performed between bands associated with different TAGs.

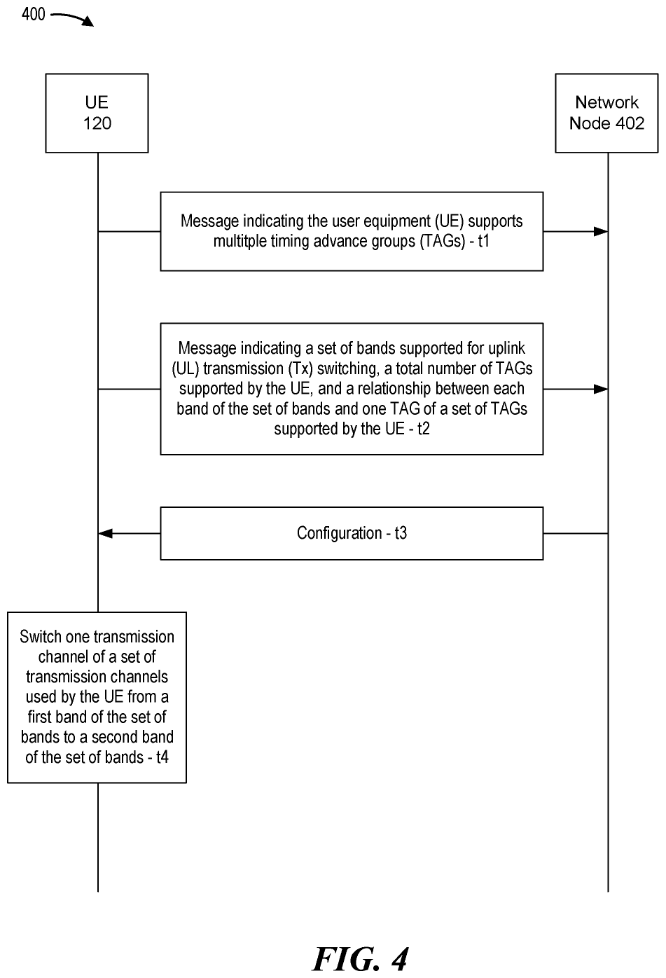

FIG. 4 is a timing diagram 400 illustrating an example of a network node 402 configuring a UE 120 for UL Tx switching, in accordance with various aspects of the present disclosure. The network node 402 may be an example of a base station 110 as described with reference to FIGS. 1 and 2, or a CU 310, DU 330, or RU 340 as described with reference to FIG. 3.

As shown in FIG. 4, at time t1, the UE 120 may transmit, to the network node 402, a first message indicating the UE supports multiple timing advance groups (TAGs). Additionally, at time t2, the UE 120 may transmit a message indicating a set of bands supported for uplink (UL) transmission (Tx) switching, a total number of TAGs supported by the UE, and a relationship between each band of the set of bands and one TAG of a set of TAGs supported by the UE, a number of TAGs in the set of TAGs being equal to or less than the total number of TAGs supported by the UE. The total number of TAGs supported by the UE 120 may be indicated via a parameter, such as supportedNumber TAG

As an example, the message may indicate the UE 120 supports a first band (band A), a second band (band B), and a third band (band C). In some examples, the message may also indicate the UE 120 supports two TAGs, such as a first TAG (TAG 1) and a second TAG (TAG 2). The message may also indicate a relationship between the set of bands and a set of TAGs supported by the UE 120. In some examples, the relationship may be shown by indicating the respective bands of the set of bands that are associated with each TAG. For example, the message may indicate bands A and B are associated with TAG 1 (e.g., TAG 1=bands A and B), and band C is associated with TAG 2 (e.g., TAG 2=band C). In other examples, the message may indicate a TAG associated with each band. For example, the message may indicate band A is associated with TAG 1 (e.g., band A=TAG 1), band B is associated with TAG 1 (e.g., band B=TAG 1), and band C is associated with TAG 2 (e.g., band C=TAG 2).

In an optional configuration, the UE 120 may indicate whether the UE 120 supports multiple TAGs with UL Tx switching. The UE 120 may not support multiple TAGs with UL Tx switching by default. In some examples, the support may be indicated via one bit. The one bit may be included with the indication of the total number of TAGs supported by the UE 120 (e.g., supportedNumberTAG).

In other examples, support for multiple TAGs with UL Tx switching may be indicated via multiple bits that identify the number of TAGs supported by the UE. For example, the multiple bits may indicate the UE 120 supports one TAG, thus each band may be associated with one TAG. Alternatively, the multiple bits may indicate the UE 120 does not support any TAGs. Reporting that the UE 120 supports one TAG or does not support any TAGs may indicate that the UE does not support multiple TAGs with UL Tx switching. In some other examples, the multiple bits may indicate the UE 120 supports multiple TAGs, such as two TAGs, three TAGs, four TAGS, or another number of TAGs, where the number is greater than two. In such examples, the set of bands may support a number of TAGs corresponding to the number of TAGs reported via the multiple bits. Reporting that the UE 120 supports multiple TAGs, via the multiple bits, may indicate that the UE supports multiple TAGs with UL Tx switching. If the UE 120 uses multiple bits to indicate support for UL Tx switching with multiple TAGs, the indication of the number of supported TAGs (e.g., supportedNumberTAG) transmitted at time t1 may be optional. If the number of supported TAGs (e.g., supportedNumberTAG) is reported at time t1, the reported number should be equal to the number of supported TAGs reported via the multiple bits.

As shown in FIG. 4, at time t3, the UE 120 receives, from the network node 402, a configuration based on transmitting the message at time t2. The configuration may be received via a radio resource control (RRC) message or a medium access control (MAC) control element (CE) (MAC-CE). In some examples, the configuration may indicate, for each band of the set of bands, a corresponding TAG of the set of TAGs. As an example, the configuration may indicate bands A and B are associated with TAG 1 (e.g., TAG 1=bands A and B), and band C is associated with TAG 2 (e.g., TAG 2=band C). In other examples, the configuration may indicate a TAG associated with each band. For example, the configuration may indicate band A is associated with TAG 1 (e.g., band A=TAG 1), band B is associated with TAG 1 (e.g., band B=TAG 1), and band C is associated with TAG 2 (e.g., band C=TAG 2).

Additionally, at time t4, the UE 120 may switch one transmission channel of a set of transmission channels used by the UE from a first band of the set of bands to a second band of the set of bands. In the example of FIG. 4, it is assumed the UE 120 supports UL Tx switching with multiple bands. The switch at time t4 may be performed based on receiving the configuration at time t3. In some examples, the UE 120 may receive, from the network node 402, a switching message (not shown in FIG. 4) configuring the UE 120 to switch the one transmission channel from the first band to the second band. That is, the first band and the second band are selected by the network node 402 from the set of bands supported by the UE 120. In such examples, the UE 120 is limited to switching within portions of the first band and second band. For example, the UE 120 switches the one transmission channel from a first portion of the first band to a second portion of the second band. In other examples, the first band and the second band are not limited to specific bands in the set of bands supported by the UE 120. The switch at time t4 may be performed during a switching period. The switching period may have a first length or a second length that is greater than the first length. Additionally, the first length may be a conventional length for the switching period. The first length may be used when the first band and the second band are associated with a same TAG. The second length may be used when the first band and the second band are associated with different TAGs.

In some examples, the UE, such as the UE 120 described with reference to FIGS. 1, 2, 3, and 4 may synchronize two or more carriers. In such examples, the UE may transmit, to one or more network nodes, information indicating a capability of the UE to support sharing of time and frequency tracking information between a first component carrier associated with a first cell and a second component carrier associated with a second cell in a carrier aggregation communication process. Based on indicating the capability, the UE may receive a signal, via a network node associated with the first cell, including one or both of a synchronization signal block (SS block) indicating first time and first frequency tracking information associated with the first cell, or a tracking reference signal (TRS) indicating first time and first frequency tracking information associated with the first cell. The UE may then determine second time and second frequency tracking information associated with the second cell based on the first time and first frequency tracking information. In such examples, the UE may track one or both of a time or a frequency based on the first time and first frequency tracking information.

FIG. 5 is a flow diagram illustrating an example process 500 performed, for example, by a user equipment (UE), in accordance with various aspects of the present disclosure. The UE may be an example of a UE 120 described with reference to FIGS. 1, 2, 3, and 4. The example process 500 is an example of receiving a configuration for UL Tx switching with multiple TAGs. As shown in FIG. 5, the process 500 begins at block 502 by transmitting, to a network node, a first message indicating the UE supports multiple timing advance groups (TAGs). At block 504, the process 500 transmits, to the network node, a second message indicating a set of bands supported for uplink transmission switching, a total number of TAGs supported by the UE, and a relationship between each band of the set of bands and one TAG of a set of TAGs supported by the UE. A number of TAGs in the set of TAGs may be equal to or less than the total number of TAGs supported by the UE. At block 506, the process 500 receives, from the network node, a configuration based on transmitting the second message. The configuration may indicate, for each band of the set of bands, a corresponding TAG of the set of TAGs

FIG. 6 is a flow diagram illustrating an example process 600 performed, for example, by a network node, in accordance with various aspects of the present disclosure. The network node may be an example of a base station 110 as described with reference to FIGS. 1 and 2, a CU 310, DU 330, or RU 340 as described with reference to FIG. 3, or a network node 402 described with reference to FIG. 4. The example process 600 is an example of transmitting a configuration for UL Tx switching with multiple TAGs. As shown in FIG. 6, the process 600 begins at block 602 by receiving a first message indicating a UE supports multiple TAGs. At block 604, the process 600 receives a second message indicating a set of bands supported for uplink transmission switching by the UE, a total number of TAGs supported by the UE, and a relationship between each band of the set of bands and one TAG of a set of TAGs supported by the UE. A number of TAGs in the set of TAGs may be equal to or less than the total number of TAGs supported by the UE. At block 606, the process 600 transmits a configuration based on receiving the second message. The configuration may indicate, for each band of the set of bands, a corresponding TAG of the set of TAGs.

Implementation examples are described in the following numbered clauses:
Clause 1. A method for wireless communication at a user equipment (UE), comprising: transmitting, to a network node, a first message indicating the UE supports multiple timing advance groups (TAGs); transmitting, to the network node, a second message indicating a set of bands supported for uplink (UL) transmission (Tx) switching, a total number of TAGs supported by the UE, and a relationship between each band of the set of bands and one TAG of a set of TAGs supported by the UE, a number of TAGs in the set of TAGs being equal to or less than the total number of TAGs supported by the UE; and receiving, from the network node, a configuration based on transmitting the second message.
Clause 2. The method of Clause 1, in which the configuration indicates, for each band of the set of bands, a corresponding TAG of the set of TAGs.
Clause 3. The method of any one of Clauses 1-2, further comprising switching one transmission channel of a set of transmission channels used by the UE from a first band of the set of bands to a second band of the set of bands.
Clause 4. The method of any one of Clause 1-3, further comprising receiving, from the network node, a switching message configuring the UE to switch the one transmission channel from the first band to the second band, in which the UE switches the one transmission channel from a first portion of the first band to a second portion of the second band.
Clause 5. The method of any one of Clauses 1-3, in which: switching the one transmission channel occurs during a switching period having: a first length based on the first band and the second band being associated with a same TAG; or a second length based on the first band and the second band being associated with different TAGs; and the second length is greater than the first length.
Clause 6. The method of any one of Clauses 1-5, in which the UE indicates support for uplink transmission switching with the multiple TAGs via one bit included in the second message.
Clause 7. The method of any one of Clauses 1-5, in which: the total number of TAGs supported by the UE is indicated via multiple bits included in the second message; and the total number of TAGs is equal to: one based on the multiple bits indicating a value of one; or the value indicated via the multiple bits based on the value being equal to or greater than two.
Clause 8. The method of any one of Clauses 1-7, in which the configuration is received via a radio resource control (RRC) message or a medium access control (MAC) control element (CE) (MAC-CE).
Clause 9. The method of any one of Clauses 1-9, further comprising: transmitting, to the network node, information indicating a capability of the UE to support sharing of time and frequency tracking information between a first component carrier associated with a first cell and a second component carrier associated with a second cell in a carrier aggregation communication process; receiving a signal, associated with the first cell, including one or both of: a synchronization signal block (SS block) indicating first time and first frequency tracking information associated with the first cell; or a tracking reference signal (TRS) indicating first time and first frequency tracking information associated with the first cell; and determining second time and second frequency tracking information associated with the second cell based on the first time and first frequency tracking information, in which the UE tracks one or both of a time or a frequency based on the first time and first frequency tracking information.
Clause 10. A method for wireless communication at a network node, comprising: receiving a first message indicating a user equipment (UE) supports multiple timing advance groups (TAGs); receiving a second message indicating a set of bands supported for uplink (UL) transmission (Tx) switching by the UE, a total number of TAGs supported by the UE, and a relationship between each band of the set of bands and one TAG of a set of TAGs supported by the UE, a number of TAGs in the set of TAGs being equal to or less than the total number of TAGs supported by the UE; and transmitting a configuration based on receiving the second message.
Clause 11. The method of Clause 10, in which the configuration indicates, for each band of the set of bands, a corresponding TAG of the set of TAGs.
Clause 12. The method of any one of Clause 10-11, further comprising transmitting a switching message configuring the UE to switch one transmission channel from a first band to a second band, in which the UE switches the one transmission channel from a first portion of the first band to a second portion of the second band based on transmitting the switching message.
Clause 13. The method of any one of Clauses 10-11, in which: the UE switches one transmission channel from a first band to a second band during a switching period based on transmitting the configuration; the switching period having: a first length based on the first band and the second band being associated with a same TAG; or a second length based on the first band and the second band being associated with different TAGs; and the second length is greater than the first length.
Clause 14. The method of any one of Clauses 10-13, in which the UE indicates support for uplink transmission switching with the multiple TAGs via one bit included in the second message.
Clause 15. The method of any one of Clauses 10-13, in which: the total number of TAGs supported by the UE is indicated via multiple bits included in the second message; and the total number of TAGs is equal to: one based on the multiple bits indicating a value of one; or the value indicated via the multiple bits based on the value being equal to or greater than two.
Clause 16. The method of any one of Clauses 10-15, in which the configuration is transmitted via a radio resource control (RRC) message or a medium access control (MAC) control element (CE) (MAC-CE).
Clause 17. A UE comprising a processor, memory coupled with the processor, and instructions stored in the memory and operable, when executed by the processor to cause the UE to perform any one of Clauses 1 through 9.
Clause 18. An apparatus configured for wireless communications comprising at least one means for performing any one of Clauses 1 through 9.
Clause 19. A computer program comprising code for causing an apparatus to perform any one of Clauses 1 through 9.
Clause 20. A network node comprising a processor, memory coupled with the processor, and instructions stored in the memory and operable, when executed by the processor to cause the network node to perform any one of Clauses 10 through 16.
Clause 21. An apparatus configured for wireless communications comprising at least one means for performing any one of Clauses 10 through 16.
Clause 22. A computer program comprising code for causing an apparatus to perform any one of Clauses 10 through 16.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication at a user equipment (UE), comprising:
transmitting, to a network node, a first message indicating the UE supports multiple timing advance groups (TAGs);
transmitting, to the network node, a second message indicating a set of bands supported for uplink (UL) transmission (Tx) switching, a total number of TAGs supported by the UE, and a relationship between each band of the set of bands and one TAG of a set of TAGs supported by the UE, a number of TAGs in the set of TAGs being equal to or less than the total number of TAGs supported by the UE; and
receiving, from the network node, a configuration based on transmitting the second message.

2. The method of claim 1, in which the configuration indicates, for each band of the set of bands, a corresponding TAG of the set of TAGs.

3. The method of claim 2, further comprising switching one transmission channel of a set of transmission channels used by the UE from a first band of the set of bands to a second band of the set of bands.

4. The method of claim 3, further comprising receiving, from the network node, a switching message configuring the UE to switch the one transmission channel from the first band to the second band,
in which the UE switches the one transmission channel from a first portion of the first band to a second portion of the second band.

5. The method of claim 3, in which:
switching the one transmission channel occurs during a switching period having:
a first length based on the first band and the second band being associated with a same TAG; or
a second length based on the first band and the second band being associated with different TAGs; and
the second length is greater than the first length.

6. The method of claim 1, in which the UE indicates support for uplink transmission switching with the multiple TAGs via one bit included in the second message.

7. The method of claim 1, in which:
the total number of TAGs supported by the UE is indicated via multiple bits included in the second message; and
the total number of TAGs is equal to:
one based on the multiple bits indicating a value of one; or
the value indicated via the multiple bits based on the value being equal to or greater than two.

8. The method of claim 1, in which the configuration is received via a radio resource control (RRC) message or a medium access control (MAC) control element (CE) (MAC-CE).

9. The method of claim 1, further comprising:
transmitting, to the network node, information indicating a capability of the UE to support sharing of time and frequency tracking information between a first component carrier associated with a first cell and a second component carrier associated with a second cell in a carrier aggregation communication process;
receiving a signal, associated with the first cell, including one or both of:
a synchronization signal block (SS block) indicating first time and first frequency tracking information associated with the first cell; or
a tracking reference signal (TRS) indicating first time and first frequency tracking information associated with the first cell; and
determining second time and second frequency tracking information associated with the second cell based on the first time and first frequency tracking information,
in which the UE tracks one or both of a time or a frequency based on the first time and first frequency tracking information.

10. An apparatus for wireless communications at a user equipment (UE), comprising:
a processor; and
a memory coupled with the processor and storing instructions operable, when executed by the processor, to cause the apparatus to:
transmit, to a network node, a first message indicating the UE supports multiple timing advance groups (TAGs);
transmit, to the network node, a second message indicating a set of bands supported for uplink (UL) transmission (Tx) switching, a total number of TAGs supported by the UE, and a relationship between each band of the set of bands and one TAG of a set of TAGs supported by the UE, a number of TAGs in the set of TAGs being equal to or less than the total number of TAGs supported by the UE; and
receive, from the network node, a configuration based on transmitting the second message.

11. The apparatus of claim 10, in which the configuration indicates, for each band of the set of bands, a corresponding TAG of the set of TAGs.

12. The apparatus of claim 11, in which execution of the instructions further cause the apparatus to switch one transmission channel of a set of transmission channels used by the UE from a first band of the set of bands to a second band of the set of bands.

13. The apparatus of claim 12, in which:
execution of the instructions further cause the apparatus to receive, from the network node, a switching message configuring the UE to switch the one transmission channel from the first band to the second band; and
the UE switches the one transmission channel from a first portion of the first band to a second portion of the second band.

14. The apparatus of claim 12, in which:
switching the one transmission channel occurs during a switching period having:
a first length based on the first band and the second band being associated with a same TAG; or
a second length based on the first band and the second band being associated with different TAGs; and
the second length is greater than the first length.

15. The apparatus of claim 10, in which the UE indicates support for uplink transmission switching with the multiple TAGs via one bit included in the second message.

16. The apparatus of claim 10, in which:
the total number of TAGs supported by the UE is indicated via multiple bits included in the second message; and
the total number of TAGs is equal to:
one based on the multiple bits indicating a value of one; or
the value indicated via the multiple bits based on the value being equal to or greater than two.

17. A method for wireless communication at a network node, comprising:
receiving a first message indicating a user equipment (UE) supports multiple timing advance groups (TAGs);
receiving a second message indicating a set of bands supported for uplink (UL) transmission (Tx) switching by the UE, a total number of TAGs supported by the UE, and a relationship between each band of the set of bands and one TAG of a set of TAGs supported by the UE, a number of TAGs in the set of TAGs being equal to or less than the total number of TAGs supported by the UE; and
transmitting a configuration based on receiving the second message.

18. The method of claim 17, in which the configuration indicates, for each band of the set of bands, a corresponding TAG of the set of TAGs.

19. The method of claim 18, further comprising transmitting a switching message configuring the UE to switch one transmission channel from a first band to a second band,
in which the UE switches the one transmission channel from a first portion of the first band to a second portion of the second band based on transmitting the switching message.

20. The method of claim 18, in which:
the UE switches one transmission channel from a first band to a second band during a switching period based on transmitting the configuration;
the switching period having:
a first length based on the first band and the second band being associated with a same TAG; or
a second length based on the first band and the second band being associated with different TAGs; and
the second length is greater than the first length.

21. The method of claim 17, in which the UE indicates support for uplink transmission switching with the multiple TAGs via one bit included in the second message.

22. The method of claim 17, in which:
the total number of TAGs supported by the UE is indicated via multiple bits included in the second message; and
the total number of TAGs is equal to:
one based on the multiple bits indicating a value of one; or
the value indicated via the multiple bits based on the value being equal to or greater than two.

23. The method of claim 17, in which the configuration is transmitted via a radio resource control (RRC) message or a medium access control (MAC) control element (CE) (MAC-CE).

24. An apparatus for wireless communications at a network node, comprising:
a processor; and
a memory coupled with the processor and storing instructions operable, when executed by the processor, to cause the apparatus to:
receive a first message indicating a user equipment (UE) supports multiple timing advance groups (TAGs);
receive a second message indicating a set of bands supported for uplink (UL) transmission (Tx) switching by the UE, a total number of TAGs supported by the UE, and a relationship between each band of the set of bands and one TAG of a set of TAGs supported by the UE, a number of TAGs in the set of TAGs being equal to or less than the total number of TAGs supported by the UE; and
transmit a configuration based on receiving the second message.

25. The apparatus of claim 24, in which the configuration indicates, for each band of the set of bands, a corresponding TAG of the set of TAGs.

26. The apparatus of claim 25, in which:
execution of the instructions further cause the apparatus to transmit a switching message configuring the UE to switch one transmission channel from a first band to a second band; and
the UE switches the one transmission channel from a first portion of the first band to a second portion of the second band based on transmitting the switching message.

27. The apparatus of claim 25, in which:
the UE switches one transmission channel from a first band to a second band during a switching period based on transmitting the configuration;
the switching period having:
a first length based on the first band and the second band being associated with a same TAG; or
a second length based on the first band and the second band being associated with different TAGs; and
the second length is greater than the first length.

28. The method of claim 24, in which the UE indicates support for uplink transmission switching with the multiple TAGs via one bit included in the second message.

29. The method of claim 24, in which:
the total number of TAGs supported by the UE is indicated via multiple bits included in the second message; and
the total number of TAGs is equal to:
one based on the multiple bits indicating a value of one; or
the value indicated via the multiple bits based on the value being equal to or greater than two.
